(19) United States
(12) Patent Application Publication
(10) Pub. No.: US 2004/0220993 A1
(43) Pub. Date: Nov. 4, 2004

(54) Low power adder

(75) Inventors: Sanu K. Mathew, Hillsboro, OR (US); Mark A. Anders, Hillsboro, OR (US); Ram Krishnamurthy, Portland, OR (US)

Correspondence Address: FLESHNER & KIM, LLP, P.O. Box 221200, Chantilly, VA, 20153-1200, US

(73) Assignee: Intel Corporation

(21) Appl. No.: 10/425,987

(22) Filed: Apr. 30, 2003

(51) Int. Cl. G06F 7/50

(52) U.S. Cl. 708/670

(57) ABSTRACT

Embodiments of the present invention generally relate to an adder. In embodiments, the adder may include two adder circuits which each process a segment of a first number and a second number. The second adder, for processing the higher order digits, may be operated at a lower voltage supply level than the first adder for processing lower order digits. Accordingly, power savings may be accomplished with a nominal time delay penalty.

### BACKGROUND OF THE INVENTION

1. Field of the Invention

The field of the invention generally relates to electronics.

2. Background of the Related Art

Electronics are very important in the lives of many people. In fact, electronics are present in almost all electrical devices (e.g. radios, televisions, toasters, and computers). Many times electronics are virtually invisible to a user because they can be made up of very small devices inside a case. Although electronics may not be readily visible, they can be very complicated. It may be desirable in many electrical devices for the electronics to become smaller and/or consume less power. Smaller devices may be more portable and convenient to use by a user. Devices that consume less power may allow a battery power supply to have a longer useful life. Also, devices that consume less power may also generate less heat during operation. The generation of heat by electronics may adversely affect the maximum efficiency of an electronic device.

### BRIEF DESCRIPTION OF THE DRAWINGS

FIG. 1 is an exemplary global diagram of a portion of a computer.

FIG. 2 is an exemplary diagram illustrating a plurality of adders which operate together to add a first number and a second number.

FIGS. 3-5 are exemplary illustrations of components of a first adder.

FIGS. 6-8 are exemplary illustrations of components of a second adder.

FIGS. 9-12 illustrate exemplary embodiments of the present invention.

### DETAILED DESCRIPTION OF PREFERRED EMBODIMENTS

Electrical hardware (e.g. a computer) may include many electrical devices. In fact, a computer may include millions of electrical devices (e.g. transistors, resistors, and capacitors). These electrical devices must work together in order for hardware to operate correctly. Accordingly, electrical devices of hardware may be electrically coupled together. This coupling may be either direct coupling (e.g. direct electrical connection) or indirect coupling (e.g. electrical communication through a series of components).

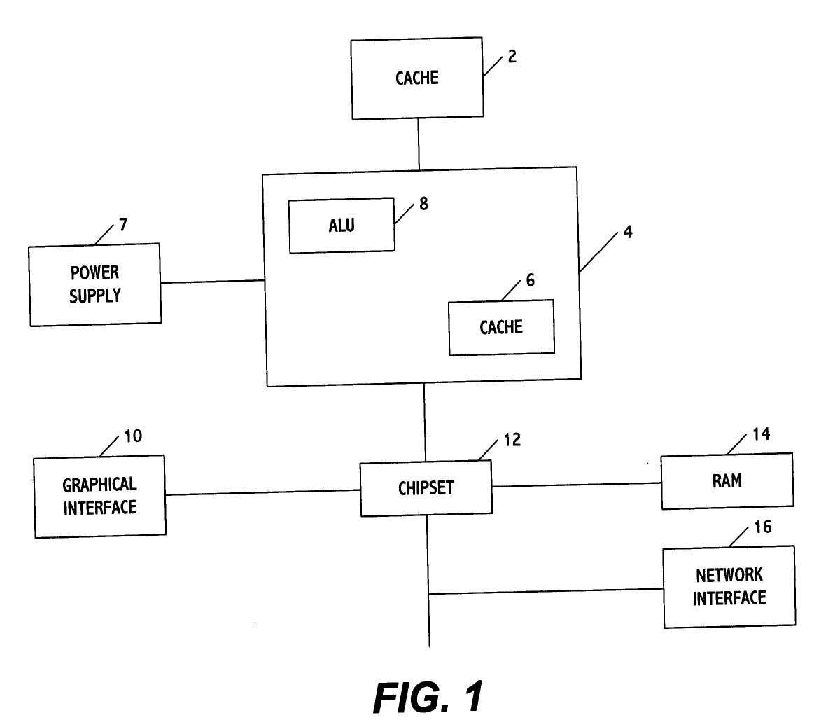

FIG. 1 is an exemplary global illustration of a computer. The computer may include a processor 4, which acts as a brain of the computer. Processor 4 may be formed on a die. Processor 4 may include an Arithmetic Logic Unit (ALU) 8 and may be included on the same die as processor 4. ALU 8 may be able to perform continuous calculations in order for processor 4 to operate. Processor 4 may include cache memory 6 which may be for temporarily storing information. Cache memory 6 may be included on the same die as processor 4. The information stored in cache memory 6 may be readily available to ALU 8 for performing calculations. A computer may also include external cache memory 2 to supplement internal cache memory 6. Power supply 7 may be provided to supply energy to processor 4 and other components of a computer. A computer may include chip set 12 coupled to processor 4. Chip set 12 may intermediately couple processor 4 to other components of a computer (e.g. graphical interface 10, Random Access Memory (RAM) 14, and/or a network interface 16). One exemplary purpose of chip set 12 is to manage communication between processor 4 and these other components. For example, graphical interface 10, RAM 14, and/or network interface 16 may be coupled to chip set 12.

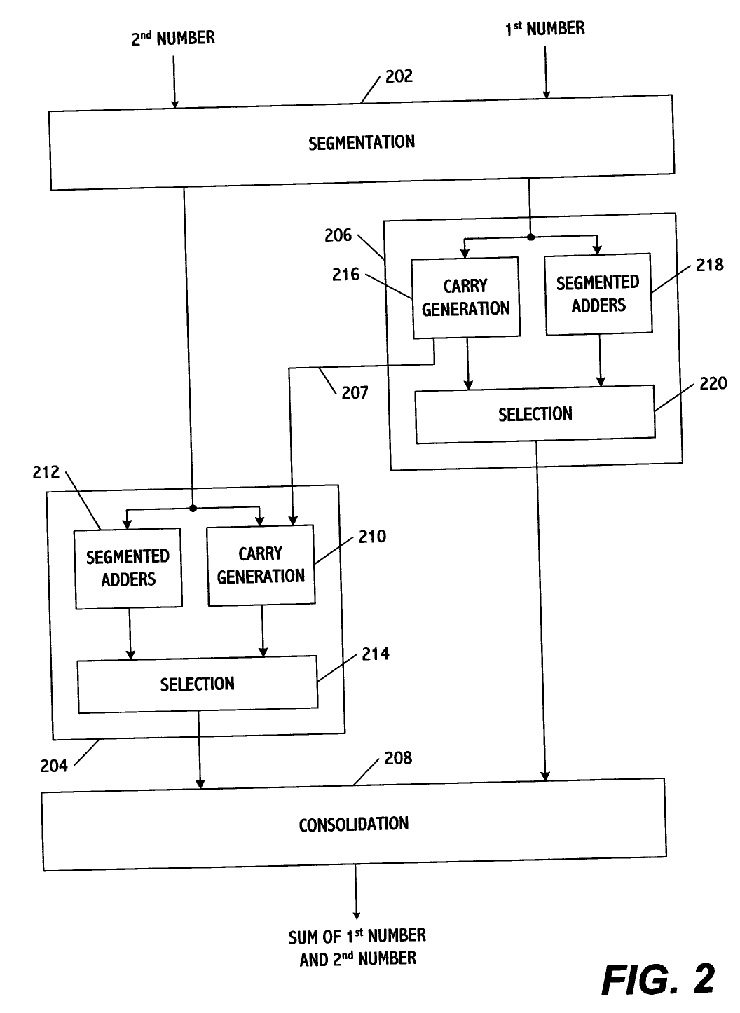

FIG. 2 is an exemplary diagram illustrating a plurality of adders which operate together to add a first number and a second number. In embodiments, the plurality of adders are included in ALU 8. In embodiments, first adder 206 and second adder 204 operate together. First adder 206 may be configured to add a portion of a first number with an associated portion of a second number. Second adder 204 may be configured to add a second portion of the first number with a second portion of the second number. In other words, first adder 206 and second adder 204 may work together to add a first number and a second number. Only two adders (first adder 206 and second adder 204) are illustrated. However one of ordinary skill in the art would appreciate that any number of adders could be used to add the first number and the second number. First adder 206 and second adder 204 are illustrated in FIG. 2 for simplification.

A first number and a second number (to be added) may be input into segmentation 202. Respective outputs of segmentation 202 may be input into first adder 206 and second adder 204. In embodiments, the first number and the second number each have a prescribed number of digits which are inputted into segmentation 202 by a plurality of parallel wire lines. Each wire line may be communicating a single digit of the first number or the second number. In embodiments, each digit is a binary digit. Segmentation 202 may be arranged to route wire lines so that first adder 206 will receive a first portion of the wire lines associated with the first number and first adder 206 will receive an associated first portion of the wire lines associated with the second number. Likewise, segmentation 202 may be arranged to route wire lines so that second adder 204 will receive a second portion of wire lines associated with the first number and second adder 204 will receive an associated second portion of the wire lines associated with the second number.

Operation of second adder 204 is dependent on an output of first adder 206. Particularly, the output of second adder 204 is affected by a carry generated from adding a first segment of a first number and a first segment of a second number in first adder 206. A carry may be a character or characters, produced in connection with an arithmetic operation when one digit place of two or more number representations, in the positional notation, are forwarded to another digit place for processing. A carry may be generated when the sum of two digits in the same digit place equals or exceeds the base of the number system in use. Aside from the dependence of a carry from first adder 206 to second adder 204, first adder 206 and second adder 204 operate independently. The outputs of first adder 206 and second adder 204 are inputs of consolidation 208.

The outputs of first adder 206 may be a plurality of parallel wire lines. Each wire line from first adder 206 may be associated with each digit of the sum of the first segment of the first number and the first segment of the second number. Likewise, the outputs of second adder 204 may be a plurality of parallel wire lines. Each wire line from second adder 204 may be associated with each digit of the sum of a second segment of the first number and a second segment of the second number. Consolidation 208 may be a routing of parallel wire lines so that a single set of wire lines representing a sum of a first number and a second number is output from consolidation 208.

Second adder 204 is dependent on output 207 of first adder 206. If first adder 206 generates a carry from a sum of a first segment of a first number and a first segment of a second number, the output of second adder 204 will be affected. Accordingly, output 207 of first adder 206 is input into second adder 204. Since the second adder 204 is dependent on output 207 to generate a sum, the operation of adder 204 lags behind the operation of first adder 206. In embodiments of the present invention, the amount of time it takes to output the sum of the first number and the second number is more heavily dependent upon the speed of operation of first adder 206 than the speed of operation of second adder 204. This may be because second adder 204 is dependent on an output from first adder 206. For example, second adder 204 may not be able to finalize adding operations until it has received an indication from first adder 206, through output 207, whether a carry was generated.

First adder 206 and second adder 204 may be comprised of a plurality of circuit elements (e.g. transistors, resistors, capacitors, and inductors). In some embodiments, the circuitry of first adder 206 and second adder 204 will operate at different speeds. The different speeds may depend on different amounts of power supplied to first adder 206 and second adder 204. For example, first adder 206 or second adder 204 may operate more quickly at a higher power supply voltage than at a lower power supply voltage. However, operation of the higher power supply voltage may result in more power consumed to perform the same adding operation. In some circumstances, the excess power consumed by a difference in voltage levels may be significant.

In embodiments of the present invention, first adder 206 may operate at a higher voltage level than second adder 204. This may be advantageous as second adder 204, operating at a lower voltage, will result in less power consumed (power saved) during the operation of adding two numbers. Further, because second adder 204 is dependent on the output of first adder 206, the slower speed by which second adder 204 will operate may only nominally effect the speed at which two numbers can be added, while significantly reducing power consumption attributes of an adding circuit including first adder 206 and second adder 204.

In embodiments, output 207 of first adder 206 is utilized at a latter stage of operations of second adder 204. Accordingly, second adder 204 may be configured to operate at a slower speed. In other words, when output 207 is generated from first adder 206, it can be utilized by second adder 204 without delay. Alternatively, if second adder 204 operates at the same power supply voltage as first adder 206, second adder 204 may have wasted idle time during which it is waiting for the output 207 to be received. Accordingly, embodiments of the present invention take advantage of the time lag of second adder 204 behind first adder 206 to save power by allowing second adder 204 to operate at a slower speed and consequently consume less power. Although some operations of second adder 204, which are not dependent on output 207 from first adder 206, may operate more slowly than if they operated at the same power voltage supply level as first adder 206, the effect of this delay may only nominally affect the delay of the sum of a first number and a second number, while conserving significant amounts of power.

In embodiments of the present invention, first adder 206 and second adder 204 may be high-speed adders which segment inputted digits and process them in parallel. By processing inputted digits (from a first number and a second number to be added) in parallel, the first number and the second number can be added in a relatively short amount of time. As shown in FIG. 2, both first adder 206 and second adder 204 include a carry generation portion (216 or 210), a plurality of segmented adders (218 or 212), and a selection portion (220 or 214). Carry generation portion (216 or 210) may operate in parallel to segmented adders (218 or 212). The two sets of digits input into either first adder 206 or second adder 204 may be further segmented into sub-segments. Each of these sub-segments may be added at the same time (i.e. in parallel) and output to selection portion (220 or 214). Carry generation portion (216 or 210) may be used in selection portion (220 or 214) to select which outputs of segmented adders (218 or 212) will be output to consolidation 208 and consequently output from consolidation 208 as the sum of the first number and the second number.

Carry generation portion (216 or 210) may perform a function of determining for each sub-segment of the first number and the second number, whether a carry will be generated from their sum. This function of carry generation portion (216 or 210) may be accomplished by logic circuitry that is independent of actually adding numbers. In other words, to speed up an operation of an adder, two sets of digits (which are to be added) are segmented into sub-segments. Each sub-segment is processed by a pair of adders. In each pair of adders, one adder adds the two sub-segments under the assumption that there will not be a carry applied from a previous sub-segment. The other adder adds the two sub-segments assuming that there will be a carry applied from a previous sub-segment. Selection circuit 220 will then chose the output of one adder of each pair of adders based on the determination of carry generation portion (216 or 210). Accordingly, all of the adders of segmented adders (218 or 212) can operate in parallel. This operation in parallel can contribute to significant time savings, as each adding of a sub-segment of digits will not be dependent on the sum of a previous sub-segment of digits.

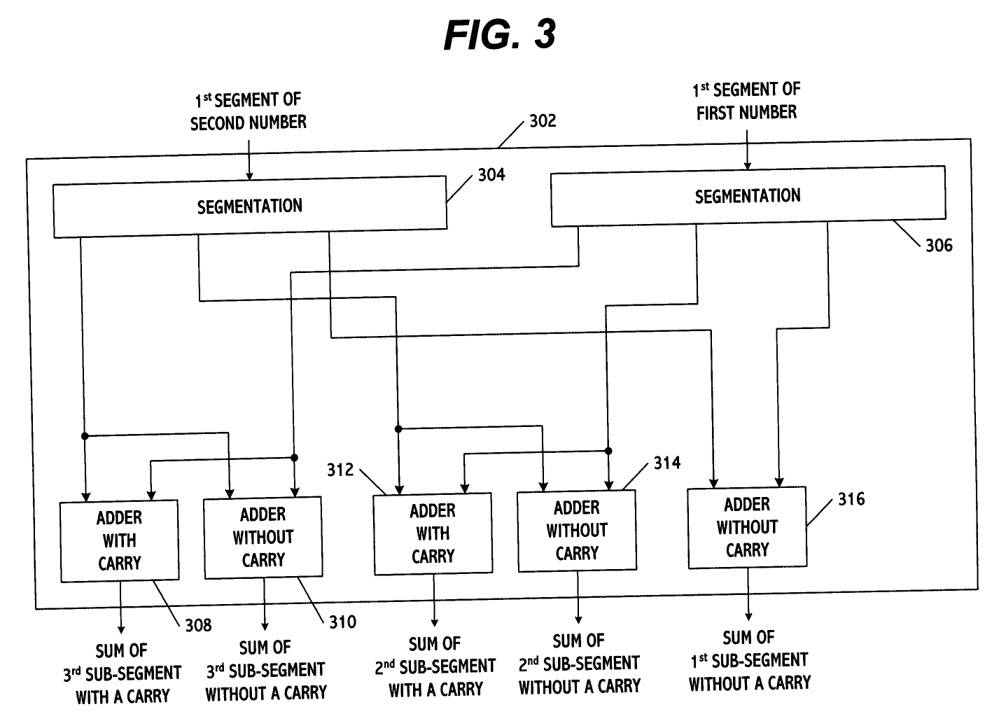

FIG. 3 is an exemplary illustration of a set of segmented adders of a low-order adder. In embodiments, segmented adder circuit 302 may relate to segmented adders 218 of FIG. 2. Segmented adder circuit 302 may receive a first segment of a first number and a first segment of a second number. The first segment of the first number and the first segment of the second number may be further segmented into a plurality of sub-segments in segmentation 304 and segmentation 306. Each of these sub-segments may then be routed to at least one of adders 308, 310, 312, 314, and 316. For exemplary purposes, segmented adder circuit 302 is illustrated as having three sub-segments. The first sub-segment has one adder 316. The second sub-segment has two adders (312 and 314) and the third sub-segment has two adders (308 and 310).

Adder 316 adds the first sub-segment of the first segment of the first number and the first sub-segment of the first segment of the second number, assuming that there will not be a carry from a previous sub-segment. In these embodiments, only one adder (e.g. adder 316) may be necessary for the first sub-segment, as the first sub-segment adds digits of the lowest order. Accordingly, since there is no previous sub-segment to the first sub-segment, there may not be circumstance for a carry to be applied to the first sub-segment. In embodiments, a pair of adders for the lowest-order sub-segment may be wasteful.

The second sub-segment includes adders 312 and 314. Adder 314 adds a second sub-segment of the first segment of the first number and a second sub-segment of the first segment of the second number, assuming that there will not be a carry from the previous sub-segment (i.e. the first sub-segment). In other words, adder 314 assumes that there will not be a carry generated from the sum produced in adder 316. Alternatively, adder 312 adds the second sub-segment of the first segment of the first number and the second sub-segment of the first segment of the second number, assuming that a carry will be applied from a previous sub-segment (i.e. the first sub-segment). In other words, adder 312 operates assuming that the sum produced from adder 316 will cause a carry to be applied in the second sub-segment. The third sub-segment includes adder 308 and adder 310. Adder 308 operates similar to adder 312, however applying the digits of a third sub-segment of a first segment of both the first number and the second number. Adder 310 operates similar to adder 314, however applying the digits of the third sub-segment of the first segment of both the first number and the second number.

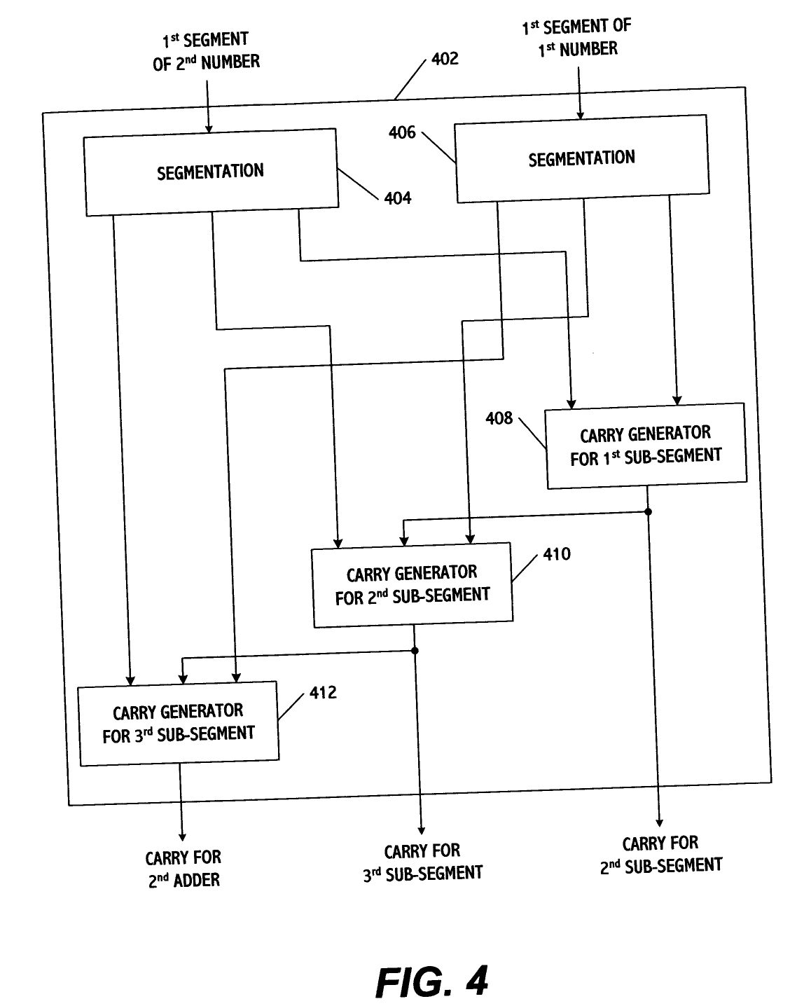

FIG. 4 is an exemplary illustration of a carry generation portion. In embodiments, carry generation portion 402 may be for a low-order adder. In embodiments, carry generation portion 402 may relate to carry generation portion 216 of FIG. 2. Carry generation portion 402 may include segmentation 404 and segmentation 406. In embodiments, segmentation 404 is similar to segmentation 304 of FIG. 3. Likewise, segmentation 406 may be similar to segmentation 306 of FIG. 3. Carry generation portion 402 may include a plurality of carry generators (408, 410, and/or 412). Only three carry generators (408, 410 and/or 412) are illustrated for exemplary purposes and simplification. Carry generator 408 may be for determining if a carry is generated in the adding of a first sub-segment of a first segment of a first number and a first sub-segment of a first segment of a second number. Accordingly, carry generator 408 may receive the first sub-segment of the first segment of the first number from segmentation 406 and the first sub-segment of the first segment of the second number from segmentation 404. Carry generator 408 may generate and output an indication of whether there will be a carry produced in the addition of the first sub-segment. In embodiments, the output of carry generator 408 is used in selection circuit 220 of FIG. 2 to choose between the output of adder 312 and adder 314 of FIG. 3.

Carry generator 410 is for a second sub-segment of the first segment of both the first number and the second number. Carry generator 410 operates similar to carry generator 408, but applied to the second sub-segment rather than the first sub-segment. Additionally, carry generator 410 receives the output of carry generator 408. This output is necessary, as the determination of whether a carry will be generated in the second sub-segment is dependent on whether a carry will be generated in the first sub-segment. Carry generator 412 operates similar to carry generator 410, except it is applied to a third sub-segment. In embodiments, the output of carry generator 410 may be used to choose between the output of adder 308 and adder 310 of FIG. 3. The output of carry generator 412 may be used in selection portion 214 of second adder 204.

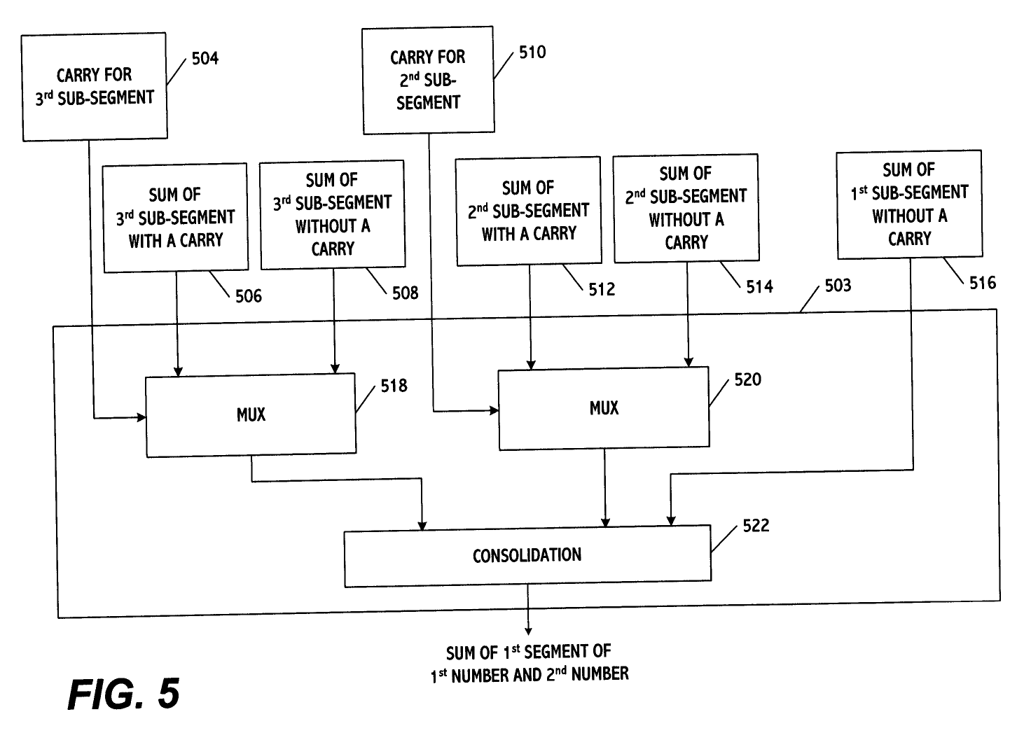

FIG. 5 is an exemplary illustration of a selection circuit. Selection circuit 502 may be implemented as selection circuit 220 of FIG. 2. Selection circuit 502 may be for a low-order adder. Selection circuit 502 may be used to select which outputs of which adders (of segmented adders) will be ultimately output as a sum of a first segment of a first number and a first segment of a second number. Selection portion 502 may include consolidation 522. Input into consolidation 522 may be input 516. Input 516 may be a sum of a first sub-segment of the first segment of the first number and second number. Input 516 may be the output of adder 316 of FIG. 3. As the first sub-segment, of a low-order adder, will not have a carry generated in a previous sub-segment, selection circuit 502 may not need to select between two inputs.

Multiplexer 520 may be for choosing a sum of a second sub-segment of the first segment of the first number and the second number. Accordingly, input 514 is a sum of a second sub-segment of the first segment of the first number and the second number, assuming that a carry will not be generated in a previous sub-segment (i.e. first sub-segment of first segment). Input 512 may be a sum of the second sub-segment of the first segment of the first number and the second number, assuming that a carry will be generated in a previous sub-segment. Input 510 may be data indicating whether a carry, from a previous sub-segment, will be applied in the second sub-segment of the first segment. In other words, input 510 will chose whether input 512 or input 514 will be output from multiplexer 520 into consolidation 522. In embodiments, input 510 is the output of carry generator 408 of FIG. 4. In embodiments, input 512 and 514 are the outputs of adder 312 and adder 314, respectively. Multiplexer 518 may operate similarly to multiplexer 520, except that a third sub-segment of the first segment is applied. In embodiments, input 504 is the output of carry generator 410. In embodiments, inputs 506 and 508 are outputs of adder 308 and adder 310, respectively.

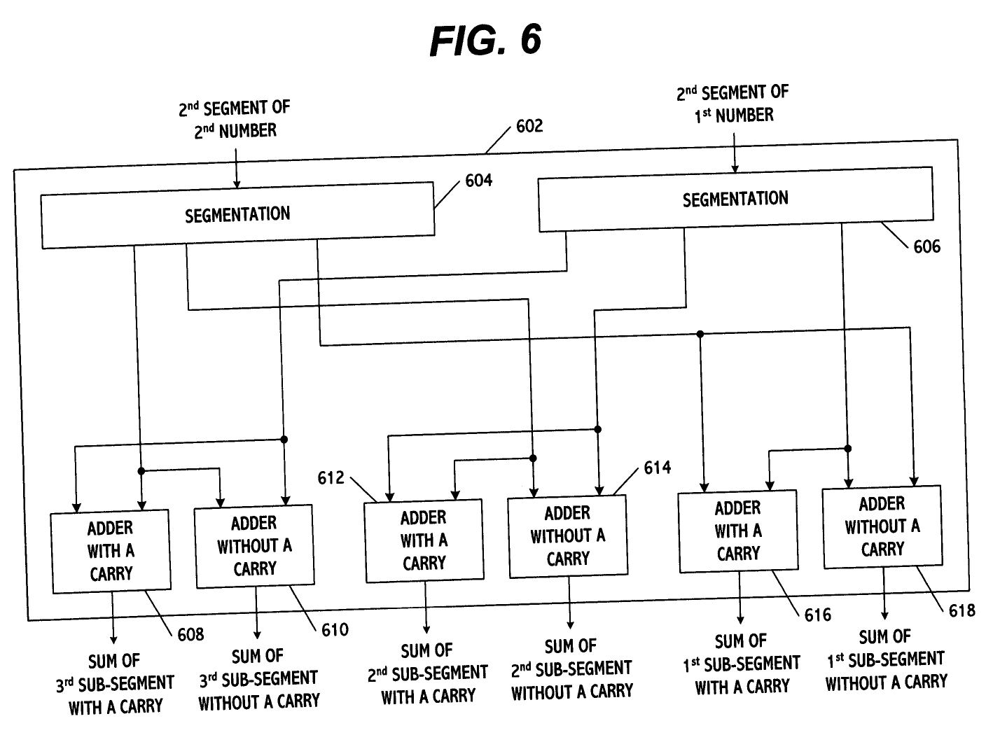

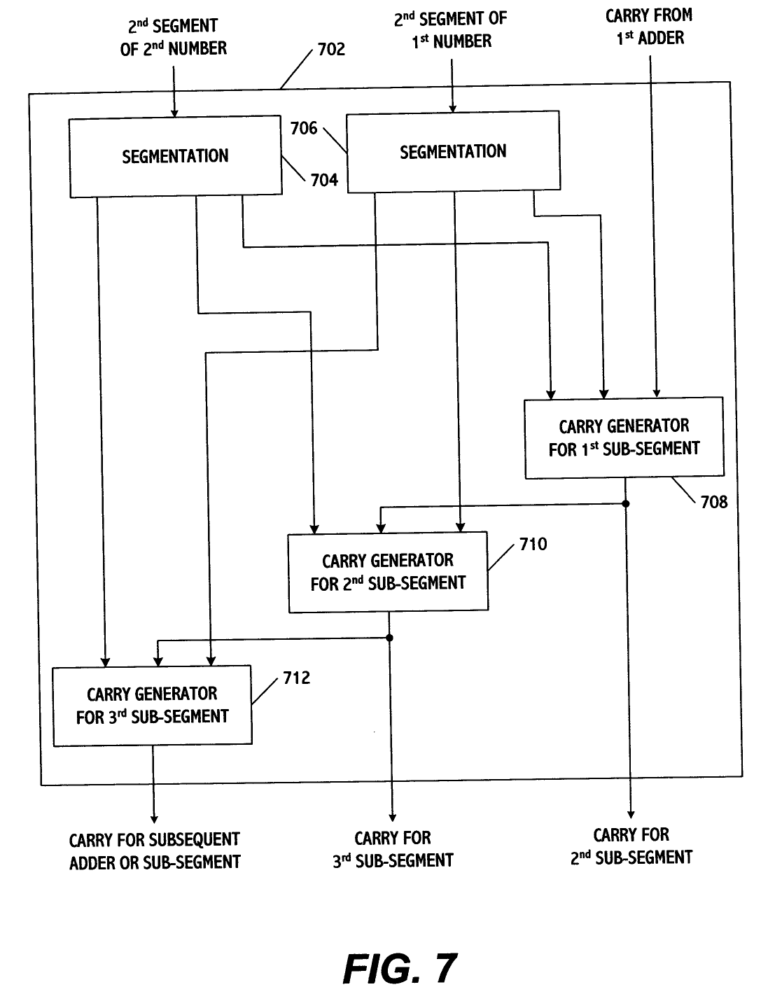

FIGS. 6, 7 and 8 may be directed to a segmented adders portion, a carry generation portion, and/or a selection portion of a high-order adder. In embodiments, segmented adder portion 602 of FIG. 6 relates to segmented adders portion 212 of FIG. 2. In embodiments, carry generation portion 702 of FIG. 7 relates to carry generation portion 210 of FIG. 2. In embodiments, selection portion 802 relates to selection portion 214 of FIG. 2.

In FIG. 6, segmented adders portion 602 is similar to segmented adders portion 302 of FIG. 3. However, selection portion 602 is configured to process a second segment of a first number and a second number. Accordingly, there may be some differences. Segmentation 604 and segmentation 606 are similar to segmentation 304 and 306 of FIG. 3. However, in segmented adder portion 602, there are two adders for the first sub-segment. This may be because in the first sub-segment of the second segment of the first number and the second number, the scenario must be considered that a carry will be generated in a previous sub-segment. The first sub-segment of the second segment may be subsequent to the third sub-segment of the first segment. In other words, the first sub-segment of the second segment may be higher-order digits than the third sub-segment of the first segment. Accordingly, a carry may be generated in the addition of the third sub-segment of the first segment. To minimize the number of components, the first sub-segment may have two adders (adders 616 and 618), while in segmented adders portion 302 have only a single adder (e.g. adder 316). Adders 612 and 614 may operate similar to adders 312 and 314 of FIG. 3, except that adders 612 and 614 are applied to the second segment. Likewise, adders 608 and 610 may operate similar to adders 308 and 310, except that adders 608 and 610 are applied to the second segment.

FIG. 7 illustrates a carry generation circuit. In embodiments, carry generation circuit 702 may be carry generation circuit 210 of FIG. 2. Further, carry generation circuit 702 may be similar to carry generation circuit 402 of FIG. 4, with some differences. Carry generation circuit 702 may receive a second segment of a first number and a second segment of a second number, similar to carry generation circuit 402 receiving a first segment of a first number and a first segment of a second number. However, carry generation circuit 702 may additionally receive a carry from first adder 206. This carry is necessary, as carry generation circuit 702 processes a subsequent segment of the first number and the second number. Segmentation 704 and 706 are similar to segmentation 404 and 406, except that segmentation 704 and 706 are applied to the second segment of the first number and the second number.

Carry generator 708 is similar to carry generator 408 of FIG. 4, except that carry generator 708 is applied to the second segment of the first number and the second number. Further, a carry from the first adder 206 (through output 207) may be input into carry generator 708. Carry generator 710 and 712 are similar to carry generators 410 and 412, except that carry generators 710 and 712 are applied to the second segment of the first number and the second number. The output of carry generator 712 may be reserved for a carry of a subsequent adder or sub-segment.

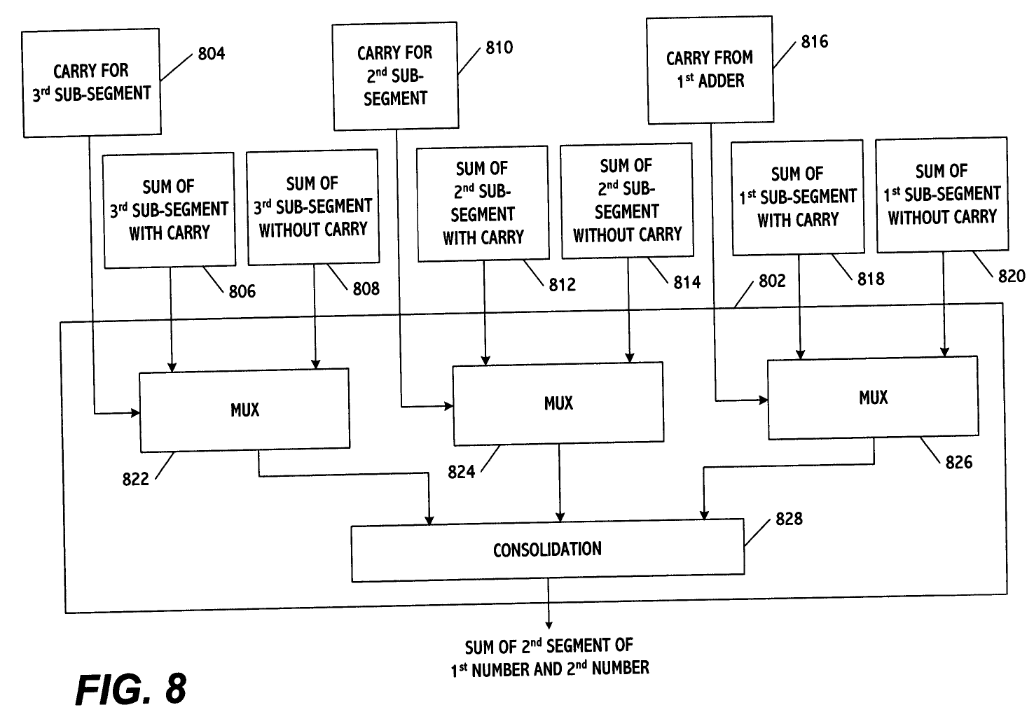

FIG. 8 is an exemplary illustration of a selection circuit in a high-order adder. Selection circuit 802 may be, in embodiments, selection circuit 212 of FIG. 2. Selection circuit 802 is similar to selection circuit 502 of FIG. 5, with some differences. Consolidation 828 of FIG. 8 may receive the outputs of multiplexers 822, 824, and 826. Multiplexers 822 and 824 may operate similarly to multiplexers 518 and 520 of FIG. 5, respectively. However, multiplexers 822 and 824 are applied to a second segment of the first and second numbers. Because the first sub-segment of the second segment may be affected by a carry generated in a previous sub-segment (e.g. the third sub-segment of the first segment), multiplexer 826 may be necessary to select from the outputs of two segmented adders.

Multiplexer 826 may receive input 818, which is the sum of a first sub-segment of a second segment of a first number and a second number, assuming that there will be a carry from a previous sub-segment. Multiplexer 826 may also receive input 820 which is a sum of the first sub-segment of the second segment, assuming that there will not be a carry from a previous sub-segment. Input 816 to multiplexer 826 selects between inputs 818 and 820 to be output to consolidation 828. In embodiments, input 820 is an output of adder 618 of FIG. 6 and input 818 is the output of adder 616 of FIG. 6. In embodiments, input 816 is the output of carry generator 412 of FIG. 4.

In embodiments, input 812 to multiplexer 824 is the output of adder 612 of FIG. 6. Likewise, input 814 may be, in embodiments, the output of adder 614 of FIG. 6. Input 810 may be the output of carry generator 708 of FIG. 7. Input 808 to multiplexer 822 may be, in embodiments, the output of adder 610 of FIG. 6. Input 806 may be, in embodiments, the output of adder 608 of FIG. 6. Input 804 may be, in embodiments, the output of carry generator 710 of FIG. 7. Accordingly, consolidation 828, may receive the outputs of multiplexers 822, 824, and 826 and may output the sum of the second segment of the first number and the second number.

The embodiments illustrated in the figures and exemplified in the written description are merely exemplary. The amount of segments and sub-segments has been illustrated using minimal segmentation for the purposes of illustration and simplification. One of ordinary skill in the art would appreciate the different combinations of segments and sub-segments may be used in the implementation of embodiments of the present invention. Additionally, one of ordinary skill in the art would appreciate that minor modifications of the structures disclosed may be implemented that are equivalent to embodiments of the present invention. For instance, one of ordinary skill in the art may appreciate that the circuitry of first adder 206 and second adder 204 may be identical, for the purposes of economical industrial production, but have modified inputs to accomplish the structures illustrated in the figures.

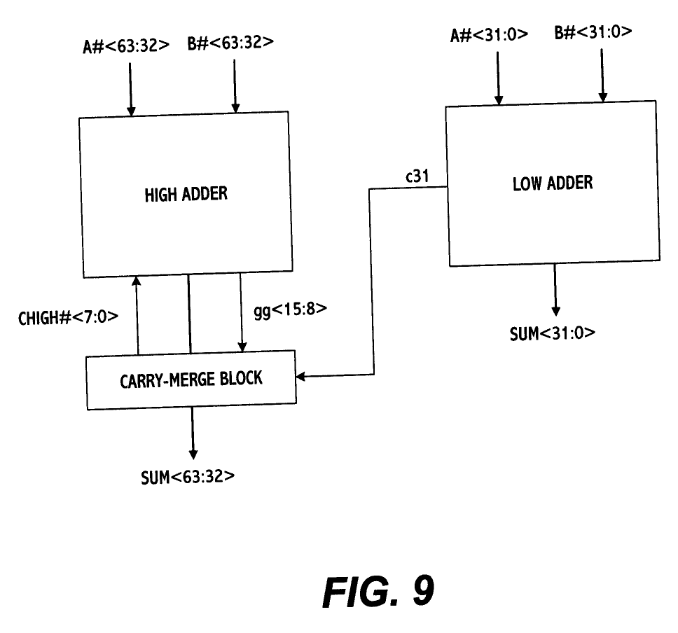

In embodiments of the present invention relating to exemplary FIGS. 9-12, ALUs are both performance and peak-current limiters in both 1A-32 and 1A-64 processors. A large amount of power which may be consumed in these processors may result in thermal density issues that may affect design reliability and robustness. One of ordinary skill in the art would appreciate that single-cycle performance of ALUs with lowered power consumption is desirable. Accordingly, an exemplary purpose of embodiments of the invention is to provide a technique of reducing power consumption by utilizing a lower supply to exploit timing slack available between the upper and lower 32 bits of a 64-bit ALU. This technique may be advantageous as there may be minimal impact on performance with considerable savings in power.

Embodiments of the invention enable a dual power supply design without necessity for level converters and without consuming static power at the interface of the upper and lower 32 bits of a 64-bit ALU. Embodiments of the present invention may also enable 18% peak power reduction with minimal (e.g. 4%) impact on performance.

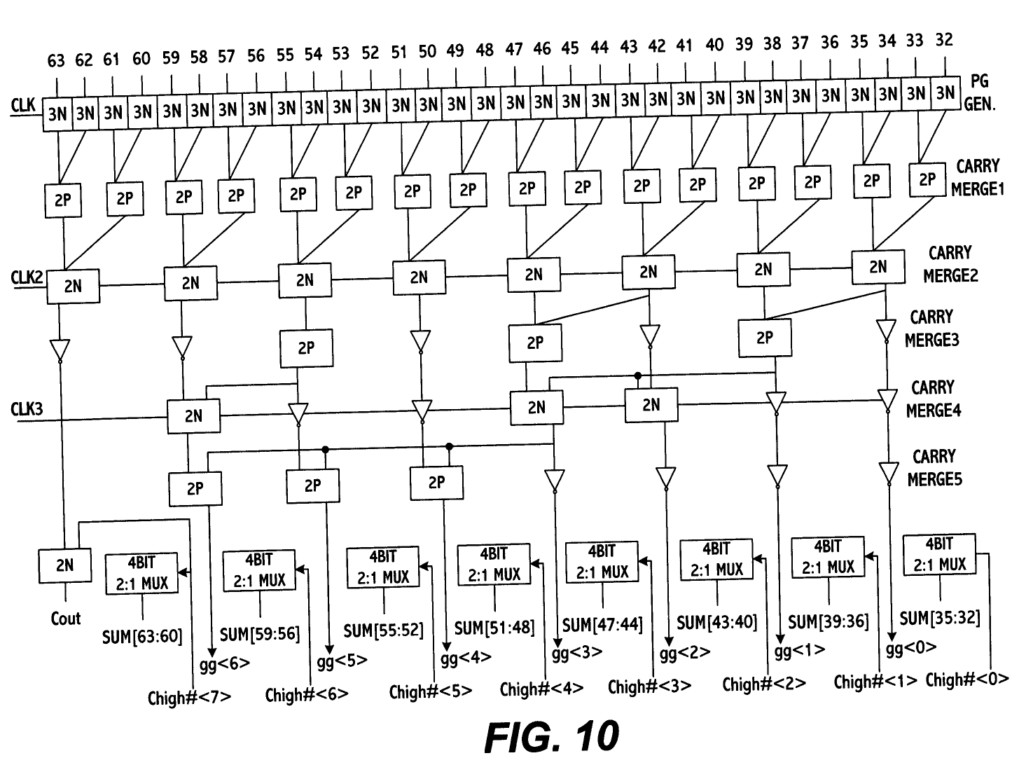

FIG. 9 illustrates a dual-Vcc ALU that uses a sparse-tree adder circuit as its basic building block. This exemplary semi-dynamic design is a high-performance low-power solution for single-cycle ADD operations. As shown in FIG. 10, the lower 32-bit sum is computed using a 7-stage 32-bit adder circuit (LowAdder). To reduce layout effort, a similar block (HighAdder) is used to compute the upper 32 bit sum. The LowAdder and HighAddder may have identical layouts. However, computation of the upper-bit sum signals (sum<63:32>) will require an extra carry-merge stage where the carryout (c31) from the lower 32 bits is merged with the carry signals of the upper 32 bits. Since the HighAdder may use the sparse-tree adder circuit illustrated in FIG. 10, the carryout signal c31 from LowAdder is merged with the group generates (gg<7:0>) of HighAdder to obtain the 1 in 4 carries (chigh#<7:0>) of the upper 32-bit block. FIG. 10 illustrates the details of the 7-stage HighAdder design, with the 4-bit group generates indicated as gg<7:0> and the 1 in 4 carries shown as chigh#<7:0>.

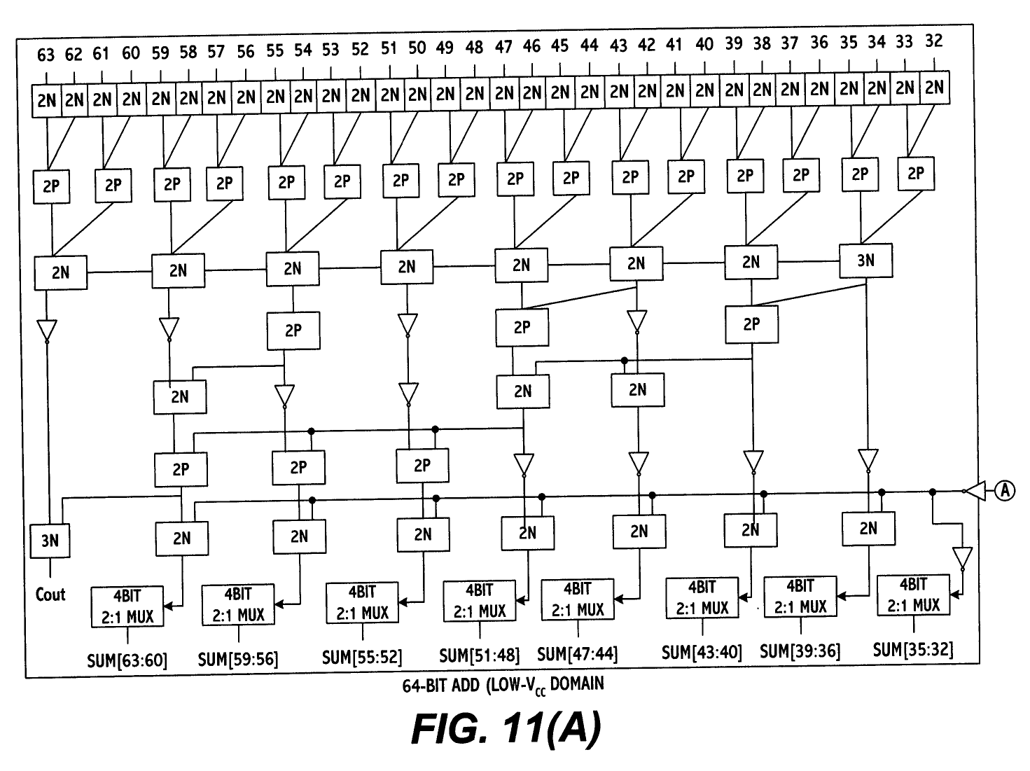

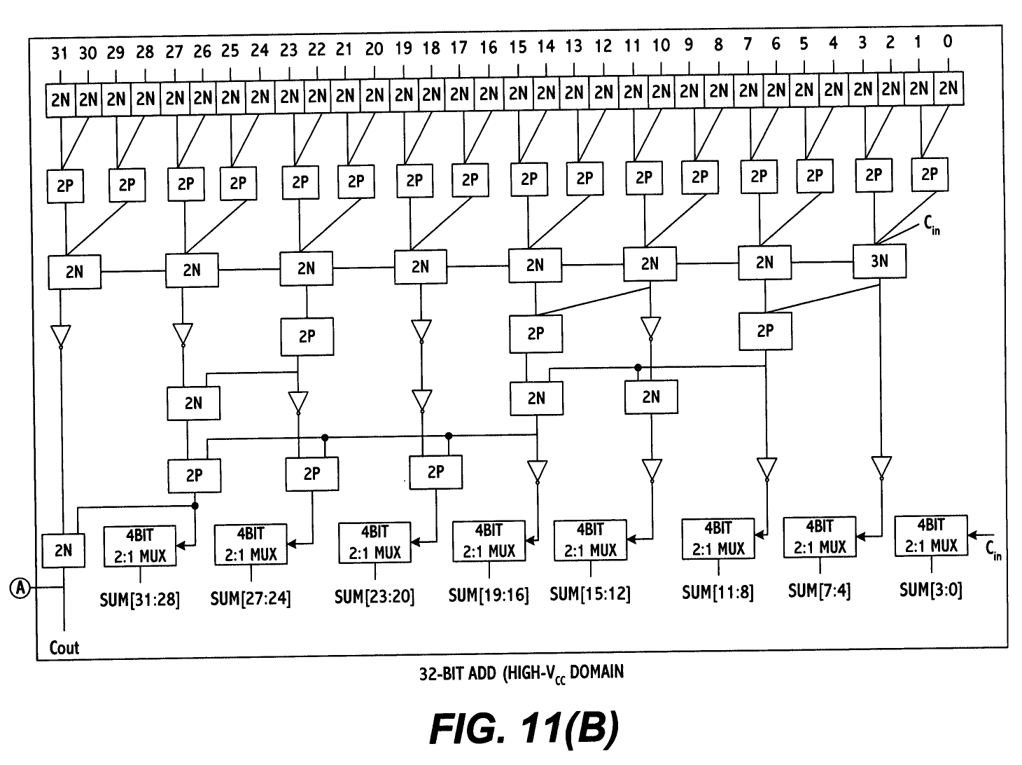

FIG. 11 illustrates an exemplary interface between LowAdder and HighAdder in accordance with embodiments of the present invention. There may be a 3-stage timing margin between the 32-bit ADD block (LowAdder) and the 64-bit ADD block (HighAdder). This stage overhead may include a Cout block, an inverter stage (to maintain logic polarity), and an extra stage of carry-merge required for the 64 bit add operation. This timing slack may be exploited by operating the 64-bit block at a lower voltage. In other words, there may be two voltage domains, one with the 32-bit ADD block (LowAdder) operating at a nominal voltage and another 64-bit block (HighAdder) operating at a lower voltage. Accordingly, switching and leakage power in the 64 bit block can be minimized without impacting performance.

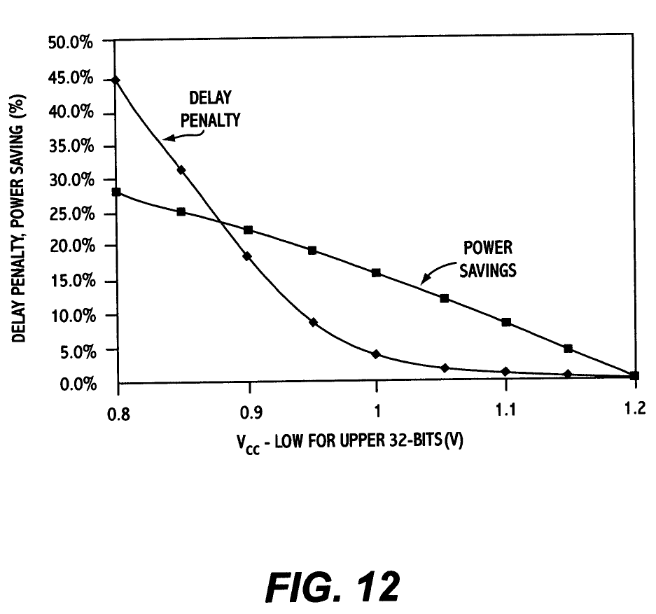

FIG. 12 is an exemplary illustration of delay penalty and power savings obtained by running the upper 32 bits at a lower voltage in embodiments of the present invention. Between 1.2V and 1V, the delay penalty is below 4%. Overhead is present because the final sum MUX and bus drivers for the upper 32 bits operate at a lower supply voltage. For example, with a 1V low-Vcc design, a 17% reduction in ALU power consumption with a 4% delay penalty may be accomplished. As the supply voltage is further lowered, timing slack between the 32-bit block and 64-bit block is consumed and the delay penalty may increase at a higher rate. There may be no delay penalty on the 32-bit block, as it operates at the higher supply voltage and does not have any stage overhead. In embodiments, since the interface between the two adder domains is dynamic in nature, there is no voltage-interface mismatch. Accordingly, problems of static power are avoided. There may be no need for using voltage level converters at a dual-Vcc interface. This may be advantageous, as the area and power overhead of using level converting circuits is avoided.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus comprising:
a first adder operating from a first voltage level; and
a second adder operating from a second voltage level, wherein:
the first voltage level and the second voltage level are different.

2. The apparatus of claim 1, wherein the apparatus is comprised in an arithmetic logic unit.

3. The apparatus of claim 2, wherein the arithmetic logic unit is comprised in a central processing unit.

4. The apparatus of claim 1, wherein:
the apparatus is configured to process a first number and a second number;
the first adder is configured to process a first segment of the first number and a first segment of the second number; and
the second adder is configured to process a second segment of the first number and a second segment of the second number.

5. The apparatus of claim 4, wherein:
the first adder is configured to output a first set of sums and a second set of sums, wherein:
each sum of the first set of sums is the sum of a sub-segment of the first segment of the first number, an associated sub-segment of the first segment of the second number, and a carry; and
each sum of the second set of sums is the sum of a sub-segment of the first segment of the first number and an associated sub-segment of the first segment of the second number.

6. The apparatus of claim 5, comprising a first carry generation circuit configured to determine for each sub-segment of the first segment whether to output a sum from the first set of sums or a sum from the second set of sums.

7. The apparatus of claim 6, wherein the determination for each sub-segment of the first segment is according to whether a carry was generated in the sum of an adjacent, lower-order sub-segment of the first segment of the first number and the second number.

8. The apparatus of claim 7, wherein the determination for each sub-segment of the first segment is performed independent of outputs of the first adder.

9. The apparatus of claim 6, comprising a first selecting circuit configured to select for each sub-segment of the first segment a sum from a first set of sums or a sum from the second set of sums according to a determination of the first carry generation circuit.

10. The apparatus of claim 5, wherein:
the second adder is configured to output a third set of sums and a fourth set of sums, wherein:
each sum of the third set of sums is the sum of a sub-segment of the second segment of the first number, an associated sub-segment of the second segment of the second number, and a carry; and
each sum of the fourth set of sums is the sum of a sub-segment of the second segment of the first number and an associated sub-segment of the second segment of the second number.

11. The apparatus of claim 10, comprising a second carry generation circuit configured to determine for each sub-segment of the second segment whether to output a sum from the third set of sums or a sum from the fourth set of sums.

12. The apparatus of claim 11, wherein the determination for each sub-segment of the second segment is according to whether:
a carry was generated in the sum of an adjacent, lower-order sub-segment of the first number and the second number; and
a carry was generated from the first adder processing the first segment of the first number and the first segment of the second number.

13. The apparatus of claim 12, wherein the determination for each sub-segment of the second segment is performed independent of an output of the second adder.

14. The apparatus of claim 11, comprising a second selecting circuit configured to select for each sub-segment of the second segment a sum from the third set of sums or a sum from the fourth set of sums according to the determination of the second carry generation circuit.

15. The apparatus of claim 4, wherein the second segment of the first number and the second segment of the second number comprise higher-order digits than the first segment of the first number and the first segment of the second number.

16. The apparatus of claim 1, wherein the second adder consumes less power than the first adder.

17. The apparatus of claim 16, wherein the first adder and the second adder process the same number of digits in each operation.

18. A method comprising:
operating a first adder from a first voltage level; and
operating a second adder from a second voltage level, wherein:
the first voltage level and the second voltage level are different.

19. The method of claim 18, wherein the method is performed in an arithmetic logic unit.

20. The method of claim 19, wherein the arithmetic logic unit is comprised in a central processing unit.

21. The method of claim 18, wherein:
the apparatus is configured to process a first number and a second number;
processing in the first adder a first segment of the first number and a first segment of the second number; and
processing in the second adder a second segment of the first number and a second segment of the second number.

22. The method of claim 21, wherein the second segment of the first number and the second segment of the second number comprise higher-order digits than the first segment of the first number and the first segment of the second number.

23. The method of claim 18, wherein the second adder consumes less power than the first adder.

24. The method of claim 23, wherein the first adder and the second adder process the same number of digits in each operation.

25. A system comprising:
a die comprising a processor; and
an off-die component in communication with the processor;
wherein the processor comprises:
a first adder operating from a first voltage level; and
a second adder operating from a second voltage level, wherein:
the first voltage level and the second voltage level are different.

26. The system of claim 25, wherein the off-die component is at least one of a cache memory, a chip set, and a graphical interface.
